(19) United States
(12) Patent Application Publication
(10) Pub. No.: US 2013/0198992 A1
(43) Pub. Date: Aug. 8, 2013

(54) WIPER BLADE

(71) Applicants: Vambi Raymundo Tolentino, Coconut Creek, FL (US); Robert Peter Peers, Boca Raton, FL (US)

(72) Inventors: Vambi Raymundo Tolentino, Coconut Creek, FL (US); Robert Peter Peers, Boca Raton, FL (US)

(73) Assignee: Pylon Manufacturing Corp., Deerfield Beach, FL (US)

(21) Appl. No.: 13/572,100

(22) Filed: Aug. 10, 2012

Related U.S. Application Data
(60) Provisional application No. 61/522,091, filed on Aug. 10, 2011.
(60) Provisional application No. 61/560,977, filed on Nov. 17, 2011.

(51) Int. Cl. B60S 1/38

(52) U.S. Cl. CPC B60S 1/38
USPC 15/250.361

(57) ABSTRACT

A cover for a windshield wiper blade having a an inner end or section, an outer end, and a longitudinal portion having a platform disposed thereon. The cover may further have a channel that can securing the cover to the elongate beam, an outer end securing mechanism that can secure the outer end of the cover to an elongate beam, and a skirt. A wiper blade having the described cover, and further having an elongate beam with a connection device attached, a wiper strip, and a collar that can be secured to the connection device.

### CROSS REFERENCE TO RELATED APPLICATIONS

This application claims the benefit of U.S. Provisional Application No. 61/522,091 filed Aug. 10, 2011 and U.S. Provisional Application No. 61/560,977 filed Nov. 17, 2011, the disclosures of which are hereby incorporated herein by reference in their entirety.

### FIELD OF THE INVENTION

This invention relates to the field of windshield wiper blades.

### BACKGROUND

Basic windshield wipers used on vehicles have a blade portion that contacts the windshield, a frame that supports the wiper strip, and a mounting base or other connection device for attaching the blade to a wiper arm. Presently, three principle styles of windshield wipers are in wide-scale use. The first style is the traditional frame windshield wiper, which implements a multi-piece frame that is directly connected to the wiper arm. The second style is the beam blade windshield wiper, which has a unitary beam that supports the wiper blade and is directly connected to the wiper arm. Wiper blades of this type have been described in U.S. patent application Ser. No. 13/453,601, which is incorporated herein by reference in its entirety. The third style is the hybrid blade windshield wiper, which combines the multi-piece frame and the unitary beam frame. Wiper blades of this type have been described in U.S. Patent Publication No. 2010/0236008, which is incorporated herein by reference in its entirety.

One problem common among many windshield wipers is a tendency to separate from the windshield during use, thus resulting in an uneven or inconsistent clearing of the windshield. This happens when a windshield wiper encounters the slipstream created by a vehicle traveling at speed and downward force on the wiper blade is overcome by wind lift created by the wiper blade. The wind lift problem has been known in the wiper field for decades, and many attempts have been made to resolve it. For example, see U.S. Pat. Nos. 3,056,991, 3,317,945, 3,879,793, 3,942,212, 6,292,974, 6,944,905.

Many prior art windshield wipers have attempted to limit windshield wiper separation from windows by the addition of spoilers or areas that create downward force on the windshield wiper. The use of windshield wiper spoilers, however, is not without drawbacks. The use of spoilers, some of which are substantial in size, increases the material costs of the windshield wipers. Additionally, and particularly as relates to beam-blade style wipers, the use of spoilers can detrimentally impact the windshield wiper performance. Specifically, the use of spoilers tends to counter or flatten the curve of the windshield wiper. Flattening of the windshield wiper, in turn, can degrade wiper strip contact with the windshield. The use of spoilers also increases material, packaging, and delivery costs associated with each windshield wiper.

In addition, as a windshield wiper travels through a wipe cycle, the angle of incidence with the airstream changes constantly. Thus, the addition of a spoiler—although generating desirable downward force—can also generate undesirable torsion, as well as pitch, and yaw forces on the windshield wiper. This, in turn can lead to uneven or inconsistent clearing of the windshield. Such forces can also increase road or wind noise and premature wear of the windshield wiper.

In addition, the use of a spoiler can be aesthetically displeasing. Spoilers can, for example, interrupt the design liner of a vehicle or otherwise distract from the more attractive features of a vehicle.

### BRIEF SUMMARY

The foregoing problems of prior art windshield wipers are resolved or at least substantially reduced and a technical advance is achieved in a windshield wiper that reduces or eliminates wind effect generated as it enters the slipstream.

According to one aspect of the present invention, a windshield wiper having neutral wind effect is provided. According to another aspect of the present invention a windshield wiper having a wind-encountering concavity is provided. According to another aspect of the present invention, a windshield wiper having aerodynamic ground effect properties is provided.

### BRIEF DESCRIPTION OF THE DRAWINGS

FIG. 1 illustrates a perspective front view of a first embodiment of a windshield wiper according to the present invention;

FIG. 2 illustrates a second perspective front view of a first embodiment of a windshield wiper according to the present invention;

FIG. 3 illustrates a side view of a first embodiment of a windshield wiper according to the present invention;

FIG. 4 illustrates a side view of a windshield wiper cover having a central concavity according to the present invention;

FIG. 5 illustrates a partial cutaway side view of a first embodiment of a windshield wiper according to the present invention;

FIG. 6 illustrates a side view of a windshield wiper cover having a central plane according to the present invention;

FIG. 7 illustrates a partial cutaway front view of a windshield wiper according to the present invention;

FIG. 8 illustrates a partial cutaway bottom view of a windshield wiper according to the present invention;

FIG. 9 illustrates a front view of a windshield wiper according to the present invention;

FIG. 10 illustrates a cutaway front view of a windshield wiper according to the present invention;

FIG. 11 illustrates a top view of a windshield wiper according to the present invention;

FIG. 12 illustrates a top view of a windshield wiper according to the present invention;

FIG. 13 illustrates a perspective front view of a windshield wiper cover according to the present invention; and

FIG. 14 illustrates a perspective front view of a unitary windshield wiper cover according to the present invention.

### DETAILED DESCRIPTION

The following detailed description and the appended drawings describe and illustrate exemplary embodiments of the invention solely for the purpose of enabling one of ordinary skill in the relevant art to make and use the invention. As such, the detailed description and illustration of these embodiments are purely exemplary in nature and are in no way intended to limit the scope of the invention, or its protection, in any manner. It should also be understood that the drawings are not to scale and in certain instances details have been omitted, which are not necessary for an understanding of the present invention, such as conventional details of fabrication and assembly.

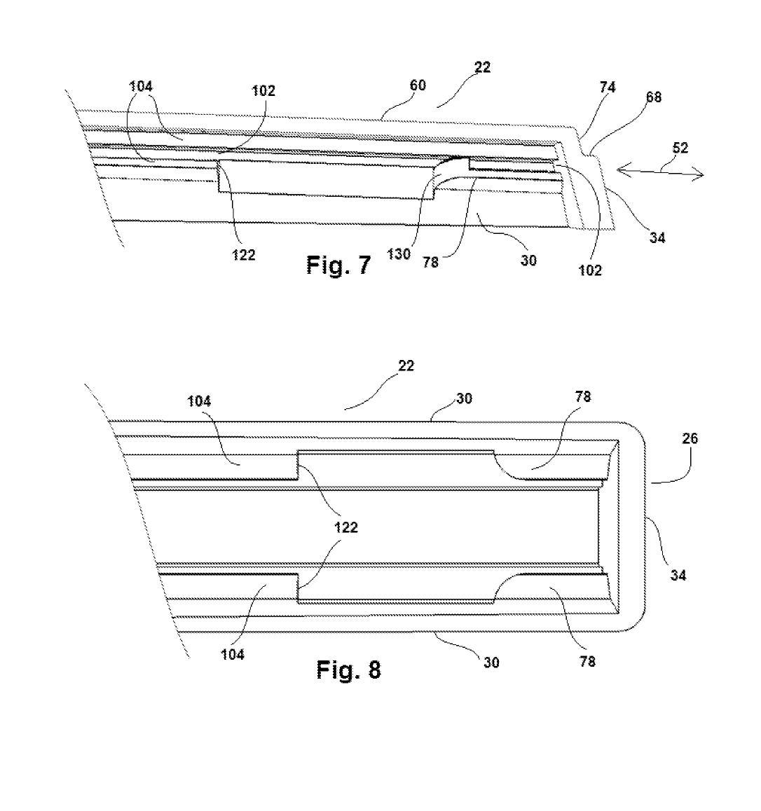

Referring to the drawings in general, a wiper blade 10 includes a cover 22, a wiper frame assembly 16 (FIG. 15), a wiper strip 48, a mounting base or other connection device 14, and a wind deflector 60. At a central region of wiper blade 10, a collar 36 defines a passageway for receiving the mounting base or other connection device 14. Collar 36 also has projections 46 (FIG. 14) and/or recesses for securing the collar to mounting base or other connection device 14. The mounting base or other connection device 14, in turn, secures the wiper blade to an connector 126 and/or an adapter which in turn secure the wiper blade to a driver arm (not shown) that actuates the wiper blade. Alternatively, some connection devices may be designed to connect to a driver arm without the use of connectors or adapters. As shown in FIGS. 7 and 8, cover 22 is also provided with end retainers 78. End retainers 78 are used to secure cover ends 26 to the wiper assembly frame 16 (FIG. 5). Additional forms of end retainers known in the art may also be used, including detents, dovetails, a claw extending around the entire perimeter of the wiper blade, or any other suitable method.

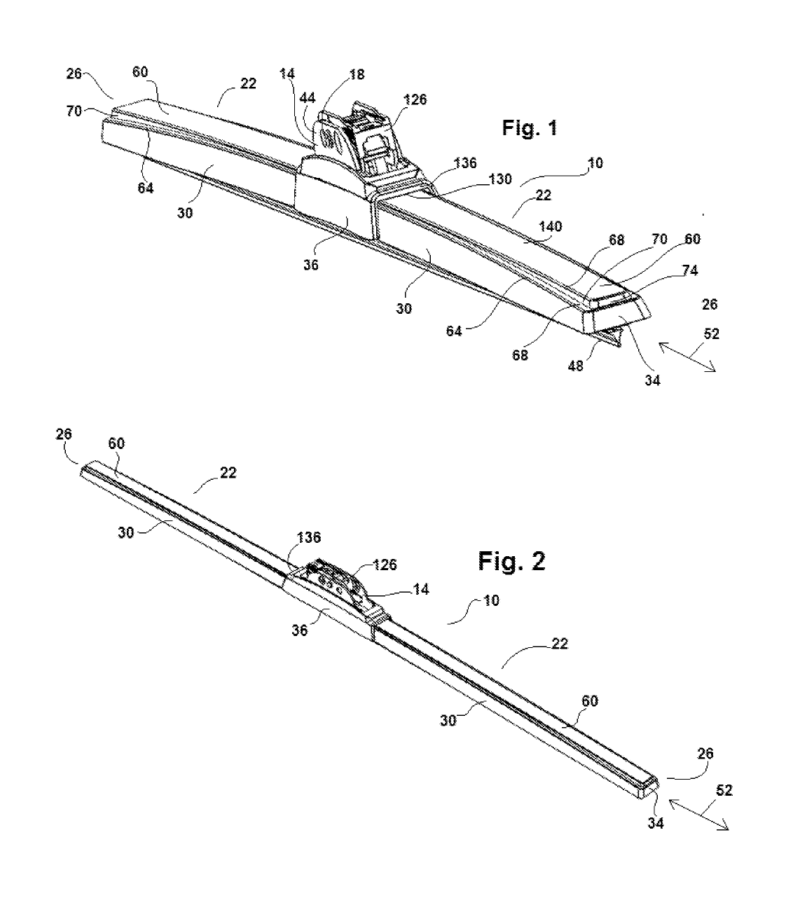

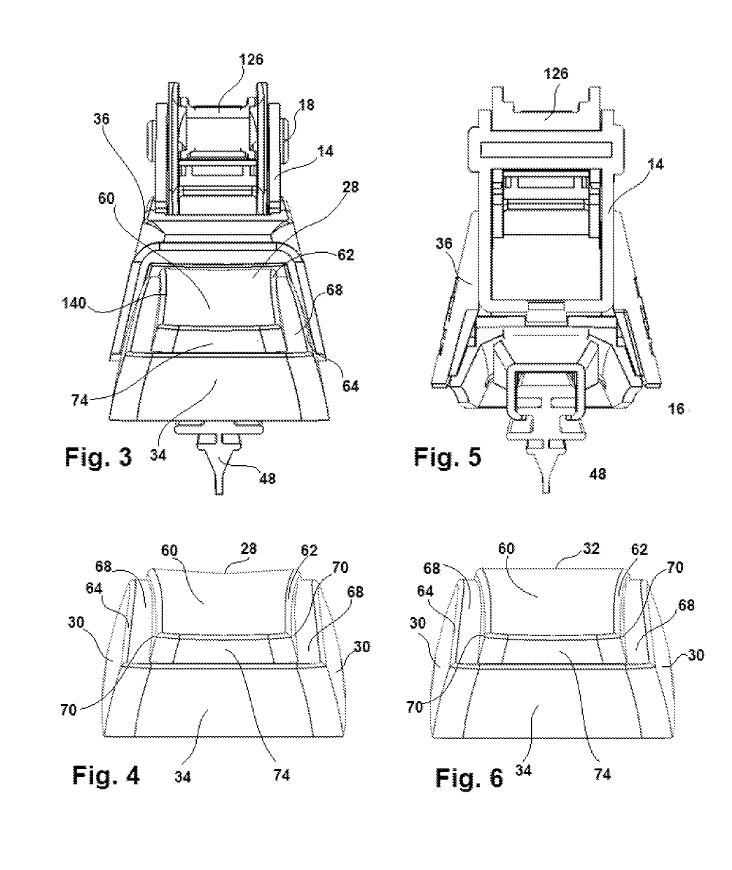

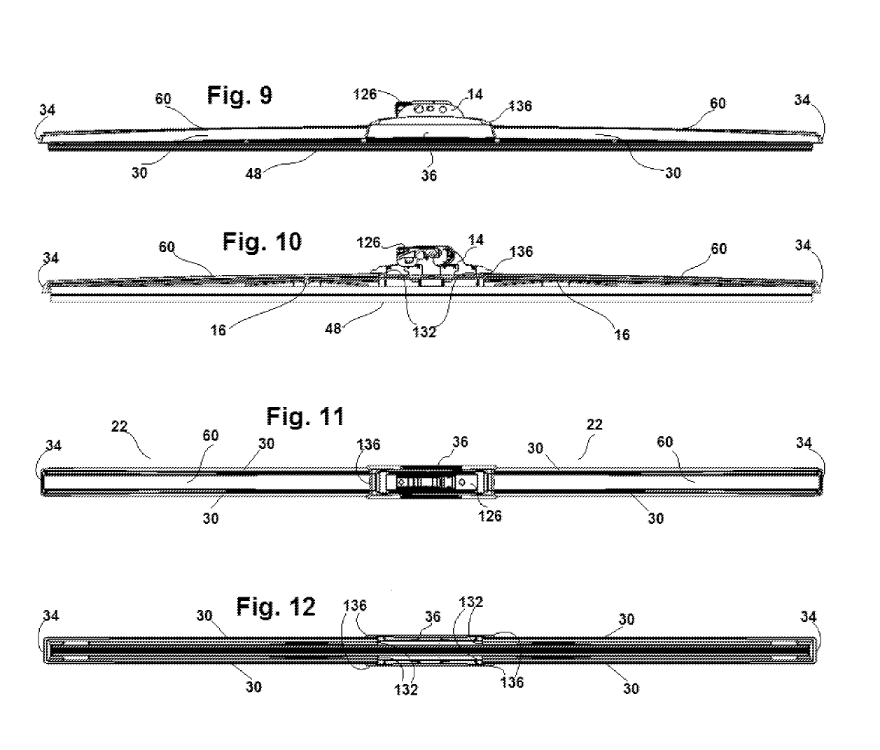

FIGS. 1-13 illustrate a first embodiment of a wiper blade having wiper covers and a central collar. In particular, as shown in FIG. 1, windshield wiper 10 has a pair of elongate windshield wiper covers 22 that extend along a longitudinal axis 52. Each cover 22 has a smooth upper surface or platform 60 that interacts with the airstream when in use. In one preferred embodiment, platform 60 is provided with a concavity 28, as illustrated in FIG. 5. Concavity 28 has the effect of, at least in part, neutralizing, reducing or eliminating excessive downward force on the windshield wiper while in use. In another preferred embodiment, platform 60 is provided without a concavity 28, but rather forms a central plane 32 as illustrated in FIG. 6. The contrast between both embodiments is best shown in a comparison of FIGS. 4 and 6. In both embodiments, platform 60 is gently sloped to limit or eliminate undesirable flattening effects on the general windshield wiper curve.

Referring to FIGS. 1, 2, 4, and 6, each cover 22 has side skirts 30 and an end skirt 34. The skirts cover a portion or all of the windshield wiper frame and internal assembly, thereby hiding from sight unattractive internal frame components of the windshield wiper. Additionally, side skirts 30 and 34 provide beneficial ground effect when the windshield wiper is in use, particularly in a vehicle traveling at high speed. That is, when a windshield wiper 10 is in use, each side skirt moves in close proximity to the windshield and through the airstream created by the moving vehicle. The side and end skirts can then draw the windshield wiper 10 toward the windshield, thereby reducing windshield wiper separation without creating the excessive downward force or ungamely appearance of some spoilers.

Cover 22 also has been provided with a perimeter landing 68. Perimeter landing 68 abuts tapered side wall 70, lateral skirt 30, and terminal skirt 34, as depicted in FIGS. 1, 3, 4, and 6. Additionally, upper chamfer 62 and lower chamfer 64, which are best illustrated in FIGS. 1, 4, and 5, are provided to reduce undesirable air vortices as the skirts and side wall travel through the airstream. Cover 22 can also be provided with a midline waist 140. Waist 140 can be a narrowed region of platform 60. Waist 140 can be optionally increased or decreased relative to perimeter landing 68.

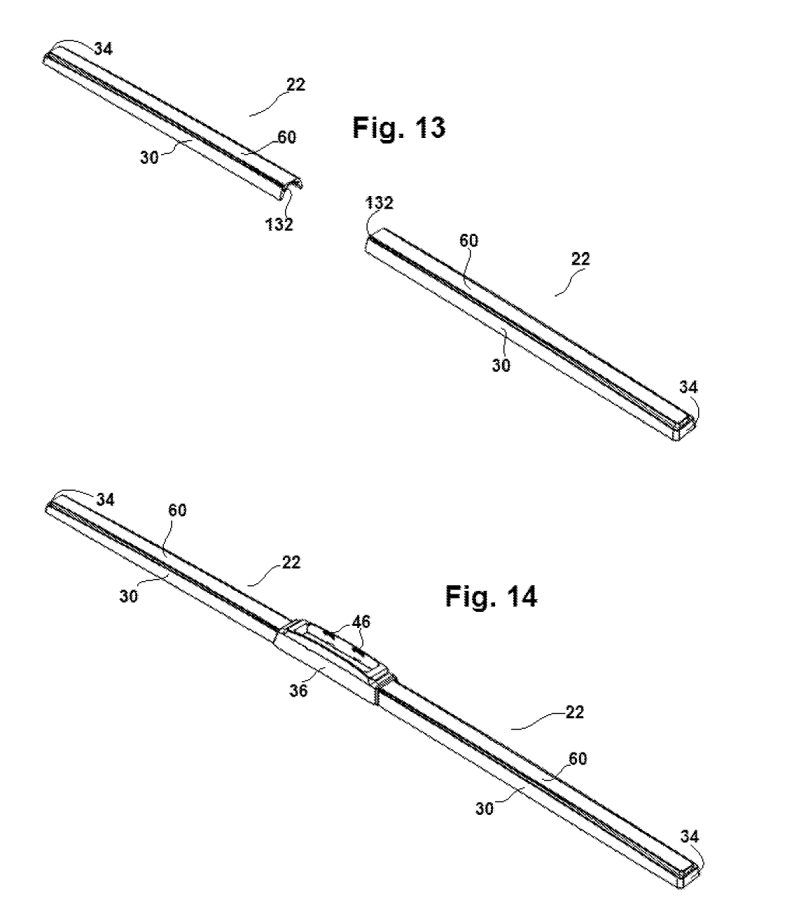

Referring to FIG. 13, cover 22 is provided with interior ends 132. Interior ends 132 are configured to be retained beneath lateral ends 136 of collar in a friction-fit engagement, as depicted in FIGS. 10 and 12. Further, as shown in FIG. 7-8, each cover 22 is attached to wiper frame assembly 16 (FIG. 5) at the cover ends using an end securing mechanism 78. As illustrated in FIG. 7, the terminal end of cover 22 is provided with cantilevered snap fit end 130 and 90 degree recesses 122 to secure the ends of cover 22 to the wiper frame assembly and limit axial movement of the wiper frame assembly.

Cover 22 is further secured to wiper frame assembly 16 (FIG. 10) by a longitudinal beam channel 102 provided on an interior portion of the wiper cover, as illustrated in FIGS. 7 and 8. Grooves 102 are formed by parallel rails 104, which are disposed axially along longitudinal axis 52. During assembly, the longitudinal edges of the wiper frame assembly are mated in a friction fit relationship with longitudinal grooves 102, thus preventing or limiting separation of cover 22 from the wiper frame assembly.

Accordingly, as discussed above, cover 22 is secured to the windshield wiper frame assembly 16 at or along three principle sections of the windshield wiper blade to avoid inadvertent detachment of the cover from the wiper frame assembly during use. These attachment sections are beneath the collar ends 136; between the ends of the cover and the ends of the beam or wiper blade frame assembly; and along the longitudinal axis of the cover and the wiper frame assembly.

FIG. 14 illustrates a third embodiment of a wiper blade, wherein the wiper covers 22 and central collar 36 are formed of a unitary construction. This embodiment eliminates the inadvertent detachment of cover 22 from wiper blade 10 at the friction-fit connection of cover end 132 and collar end 136.

Any other undisclosed or incidental details of the construction or composition of the various elements of the disclosed embodiments of the present invention are not believed to be critical to the achievement of the advantages of the present invention, so long as the elements possess the attributes needed for them to perform as disclosed. Certainly, one of ordinary skill in this art would be able to conceive of a wide variety of valve shapes and sizes and successful combinations of the invention disclosed herein. The selection of these and other details of construction are believed to be well within the ability of one of even rudimentary skills in this area, in view of the present disclosure.

Illustrative embodiments of the present invention have been described in considerable detail for the purpose of disclosing the practical, operative structure whereby the invention may be practiced advantageously. The designs described herein are intended to be exemplary only. The novel characteristics and features of the present invention may be incorporated in other structural forms without departing from the spirit and scope of the present invention. The invention encompasses embodiments both comprising and consisting of the elements described with reference to the illustrative embodiments. The invention illustratively disclosed herein suitably may be practiced in the absence of any element which is not specifically disclosed herein. The invention illustratively disclosed herein suitably may also be practiced in the absence of any element which is not specifically disclosed herein and that does not materially affect the basic and novel characteristics of the claimed invention.

1. A wiper blade, comprising:
a wiper blade assembly comprising:
an elongate beam;
a connection device;
a wiper strip, the connection device and the wiper strip being connected to the elongate beam;
a collar having a securing means for securing the collar to the connection device;
a cover comprising:
an inner end, an outer end, and a longitudinal portion therebetween;
a platform disposed on the longitudinal portion;
a channel means for securing the cover to the elongate beam, and an outer end securing means for securing the outer end of the cover to the elongate beam; and
a skirt connected to the cover.

2. The windshield wiper of claim 1, further comprising:
a second cover comprising:
an inner end, an outer end, and a longitudinal portion therebetween;
a platform disposed on the longitudinal portion;
a channel means for securing the second cover to the elongate beam, and an end securing means for securing the outer end of the cover to the elongate beam; and
a skirt connected to the second cover.

3. The windshield wiper of claim 2, wherein the platform of each cover defines a concavity.

4. The windshield wiper of claim 3, further comprising a landing connecting the platform of each cover to the skirt.

5. The windshield wiper of claim 2, wherein the platform defines a planar surface.

6. The windshield wiper of claim 5, further comprising a landing connecting the platform of each cover to the skirt.

7. The windshield wiper of claim 1, wherein the platform defines a concavity.

8. The windshield wiper of claim 7, further comprising a landing connecting the platform of each cover to the skirt.

9. The windshield wiper of claim 1, wherein the platform defines a planar surface.

10. The windshield wiper of claim 9, further comprising a landing connecting the platform of each cover to the skirt.

11. The windshield wiper of claim 1, wherein the cover further comprises an inner end securing means for securing the cover to the inner end of the beam.

12. The windshield wiper of claim 11, wherein the inner end securing means comprises a tongue being friction-fit between collar and the beam.

13. The windshield wiper of claim 2, further comprising a first slope connecting the collar to the cover and a second slope connecting the collar to the second cover.

14. A windshield wiper cover comprising:
an elongate body having a central collar and first and second covers connected to the central collar, the first and second covers having outer ends;
the central collar defining an interior passageway, the interior passageway having a snap-fit tongue;
a channel disposed along each of the first and second covers and extending from the central collar to the outer ends;
a cover end retainer defined at the outer ends; and
a platform on each of the covers.

15. The windshield wiper of claim 14, wherein the platform defines a concavity.

16. The windshield wiper cover of claim 15, further comprising a skirt connected to the platform.

17. The windshield wiper cover of claim 14, wherein the platform defines a planar surface.

18. The windshield wiper cover of claim 17, further comprising a skirt connected to the platform.
